(19) United States
(12) Patent Application Publication
(10) Pub. No.: US 2002/0083882 A1
(43) Pub. Date: Jul. 4, 2002

(54) Method for production of a whistling sound

(76) Inventors: Michael Severinovsky, Plainedge, NY (US); Marina Severinovsky, Plainedge, NY (US)

Correspondence Address: Michael Severinovsky, 507 Whittier Av., Plainedge, NY, 11756, US

(21) Appl. No.: 09/754,617

(22) Filed: Jan. 4, 2001

(51) Int. Cl. G10K 5/00

(52) U.S. Cl. 116/137 R; 446/216

(57) ABSTRACT

A piece of plastic tape (1) stretched out and positioned it in the horizontal plane between upper lip (2) and lower lip (3). The edge of tape that is nearest to the lips shall be tangential to lips surface.

### BACKGROUND—FIELD OF INVENTION

This invention is related to methods for the production of a sound by a human being as a signal in an emergency situation.

### BACKGROUND—DESCRIPTION OF PRIOR ART

All patented methods for production of a loud emergency sound require the use of mechanical or electrical devices. These mechanical or electrical devices need to be manufactured and have to be available to a person in case of an emergency. This is practically impossible, because most people who get into an emergency situation did not expect it to happen. Commercially produced devices for creating an emergency signal may entail instruction or training for the person using them. Most natural disasters or major accidents are unpredictable. People who are caught in the middle of a disaster or accident are either unequipped with commercially produced devices or incapable of using them. Devices may become unusable as a result of accident or disaster. Therefore the production of a loud sound by a person, employing only his natural ability, is the only method of attracting attention and saving ones own life. However, the natural abilities of human beings to produce loud sounds are limited to voice signals produced by throat and tongue or to whistling signals produced by lips and lungs. Voice signals require a great deal of energy and can't be used for extended periods of time, because vocal chords are easily strained. That leaves whistling as the only applicable method for producing emergency sound for a long period of time, and the ability to produce a whistle varies with each individual.

Therefore emergency sound producing devices that employ mechanical or electrical means can have a number of disadvantages:

1) They may be unreachable in an emergency situation

2) They require special knowledge or training of the person using them

3) They can be damaged during disaster or accident and rendered unusable in time of need.

On the other hand, people can not depend on their natural ability to produce a long, loud whistling emergency sound.

### SUMMARY

In accordance with the present, the invention is a method for production of a whistling sound by utilizing plastic tape, such as polyethylene or cellophane

### OBJECTS AND ADVANTAGES

Accordingly, several objects and advantages of the present invention are:

1) A piece of plastic tape can be found in any location, such as one's pocket, purse. bag, most packaging materials such as cigarette box wrapper, credit card inserts in wallet, plastic disposal bags, etc.

2) The method of using plastic tape for producing a long, loud whistling emergency sound can be employed by any person regardless of age and sex without employing special knowledge or training, and ability to do it is universal amongst all individuals.

3) The plastic tape is practically non damageable.

### DRAWING FIGURES

The drawings show:

1) Shape and size of piece of a plastic tape necessary to produce a whistling sound.

2) Schematic diagram that shows the relative position of the piece of plastic tape to a person's lips.

FIG. 1 shows shape and size of a piece of plastic tape.

FIG. 2 shows schematic diagram of relative position of a piece of plastic tape to a person's lips.

Reference Numerals in Drawing.

1 piece of plastic tape

2 upper lip

3 lower lip

### DESCRIPTION

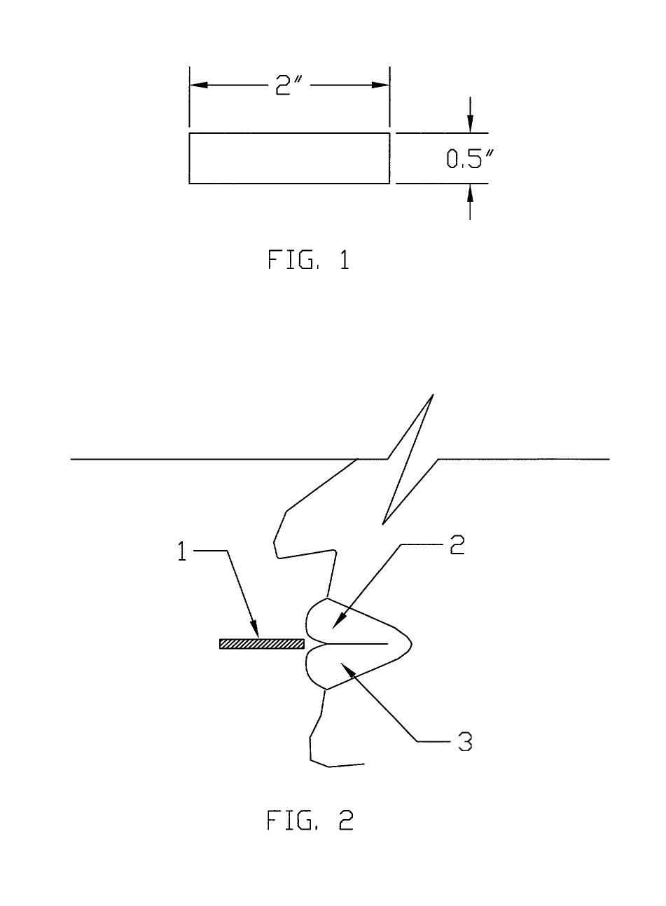

FIG. 1 shows a piece of plastic tape of minimum necessary size 2″L×1/2W The thickness of tape may vary, because different plastic used for disposal bags or product wrapping may be utilized.

FIG. 2 shows the position of plastic tape 2″½″ relative to a person's lips at the moment of producing a whistling sound. The piece of tape shall be positioned at the horizontal plane dividing the upper and lower lip. The edge of the tape that is nearest to the lips shall be tangential to lip surface. The tape shall be stretched out using hands or prefabricated supporting frame.

### ADVANTAGES

1) The piece of tape size 2″×½″ can be easily obtained from any plastic objects such as wrapping or plastic bags.

2) Tearing off a piece of plastic tape needed to produce a whistling sound does not require tools, training or physical strength and can be done by any person.

3) Utilizing the method invented by us guarantees that any person, regardless of age, sex or ability can produce a loud whistling emergency signal for a considerable duration of time without tiring.

### OPERATION

To produce a loud whistling sound utilizing a piece of polyethylene tape a person must:

1. Take a suitable piece of plastic tape sized approximately 2“L×½″W into two hands, using thumb and index fingers

2. Stretch out a piece of tape as tightly as possible and place it in the horizontal plane between upper and lower lip. The edge of tape that is nearest to the lips shall be tangential to lips surface.

3. Inhale and blow on tape trough closed lips

4. For repetition of whistling sound repeat step 3.

### CONCLUSION

Advantages of the present invention are:

1) The plastic tape utilized for this invention is an easy to find material

2) The whistling emergency sound can be produced by any person, regardless of age, sex or ability, without employing special knowledge or training.

3) The plastic tape is practically non- damageable in situations of disaster or accident such as earthquake, flood, avalanche, terrorist act, people lost at sea, mountains or woods.

4) The whistling sound is the loudest sound that can be produced by a person utilizing only his natural abilities.

5) Whistling is the most universal signal and is understood and recognized by rescue dogs and sound locating devices.

6) In addition, mass production can produce a whistling device, which uses plastic tape already stretched on some supporting frame, which would allow the utilization of this type of whistle using only one hand and lips. This mass production can make a whistle part of items used every day, such as wallets, key chains or reading glasses cases.

We claim:

1. A method for production of a whistling sound by utilizing a piece of plastic tape:
a. a piece of plastic tape is stretched out by persons' hands
b. a piece of plastic tape is stretched out on prefabricated supporting frame
